(19) United States
(12) Patent Application Publication
(10) Pub. No.: US 2004/0228613 A1
(43) Pub. Date: Nov. 18, 2004

(54) Editing and display controller used in portable digital image capture device and method of the same

(75) Inventors: Jing-Shun Lin, Kweishan (TW); Tsai Chao Lien, Kweishan (TW); Ying Hao Hsu, Kweishan (TW)

Correspondence Address: Richard P. Berg, Esq., c/o LADAS &PARRY, Suite 2100, 5670 Wilshire Boulevard, Los Angeles, CA, 90036-5679, US

(73) Assignee: BENQ CORPORATION

(21) Appl. No.: 10/840,904

(22) Filed: May 7, 2004

(30) Foreign Application Priority Data
May 16, 2003 (TW) 092113279

(51) Int. Cl. H04N 5/76; G11B 27/00; G09G 5/00

(52) U.S. Cl. 386/52; 345/723

(57) ABSTRACT

An editing and display controller used in a portable digital image capture device allows users to edit image files and to perform further displaying. Each of the image files comprises a comment column and a corresponding image. The device comprises an on screen display controller, an editing controller, and a display controller. The editing controller comprises an input interface and a compiling module. The input interface provides input options of a plurality of image and character editing functions and permits the users to edit the corresponding image and character in at least one target image file. The compiling module compiles the selected inputs received by the input interface as a corresponding control code and records the control code in the comment column of the target image file in a way that does not destroy the image of the target image file to achieve the non-destructive editing.

### BACKGROUND OF THE INVENTION

1. Field of the Invention

The present invention relates to an editing and display controller used in a portable digital image capture device, especially the digital image capture device can directly edit different image display functions and word messages of the captured image and perform further briefing.

2. Description of the Prior Art

For people who often go different places to attend meetings, they often need to carry a lot of documents or a notebook so as to give briefings. Sometimes they will need to take some background scenes as part of the content of the brief. Under this requirement, people usually utilize a digital still camera (DSC) to take pictures and send the files to a notebook to be edited, or with a conventional camera, they take, develop, scan, then send the pictures to a computer to be edited. However, these processes are not only all quite complicated and inconvenient, but they also waste time and need to utilize additional equipments. The instant requirement is often not satisfied. Therefore, the objective of the present invention is to provide an improvement of a portable digital image capture device, such as the instant editing and display controller inside digital cameras, to solve the problem of inconvenience of the prior art.

### SUMMARY OF THE INVENTION

The objective of the present invention is to provide an editing and display controller used in a portable digital image capture device, especially the digital image capture device can directly edit different image display functions and word messages of the captured image and further display with a built-in image display module, or perform further briefing by connecting to an external projector.

In one embodiment, the present invention provides an editing and display controller used in a portable digital image capture device for users to edit a plurality of image files captured by the digital image capture device and for further briefing. Each of the image files comprises a comment column and a corresponding image. The digital image capture device comprises an image capture module for capturing the plurality of image files, an image storage module for storing the plurality of image files, an image display module for displaying the plurality of image files, an on screen display (OSD) controller, an editing controller, and a display controller. The editing controller comprises an input interface and a compiling module. The input interface provides input options for a plurality of image and character editing functions and permits the users to edit the corresponding image and character in at least one target image file. The compiling module compiles the selected inputs received by the input interface as a corresponding control code and records the control code in the comment column of the target image file in a way that does not destroy the image of the target image file, thus achieving the non-destructive editing of the target image file. Moreover, the display controller comprises an image function module and a decompiling module. The image function module is used for providing a plurality of predetermined image display functions. The decompiling module is used for decompiling the control code recorded in the comment column of the target image file; according to the decompiled control code, it enables the image function module to display the images of the target image file by the edited image display function. Also, it enables the OSD controller to render the characters of the target image file by the edited character rendering function.

The editing and display controller used in a portable digital image capture device of the present invention provides a new method for editing briefing. The present invention provides a plurality of predetermined image display functions for users to select, input, and edit to the comment column of the target image files, so as to assemble all the functions of capturing, editing, and displaying in a portable digital device for users to brief more conveniently.

The advantage and spirit of the invention may be understood by the following recitations together with the appended drawings.

### BRIEF DESCRIPTION OF THE APPENDED DRAWINGS

FIG. 1 is a schematic diagram of the editing brief system used in a portable digital image capture device according to the present invention.

FIG. 2 is a function block diagram of the digital image capture device shown in FIG. 1.

FIG. 3 is a function block diagram of the editing brief system shown in FIG. 2.

FIG. 4 is a schematic diagram of an OSD menu and a corresponding look-up table shown in FIG. 3.

FIG. 5 is an embodiment of an illustration look-up table shown in FIG. 4.

FIG. 6 is an embodiment of an image display function look-up table shown in FIG. 4.

FIG. 7 is an embodiment of a character look-up table shown in FIG. 4.

FIG. 8 is an embodiment of a character color look-up table shown in FIG. 4.

FIG. 9 is an embodiment of a character rendering function look-up table shown in FIG.4.

FIG. 10 is a flowchart of compiling an image file with the editing brief system shown in FIG. 3.

FIG. 11 is a flowchart of decompiling an image file with the editing brief system shown in FIG. 3.

### DETAILED DESCRIPTION OF THE INVENTION

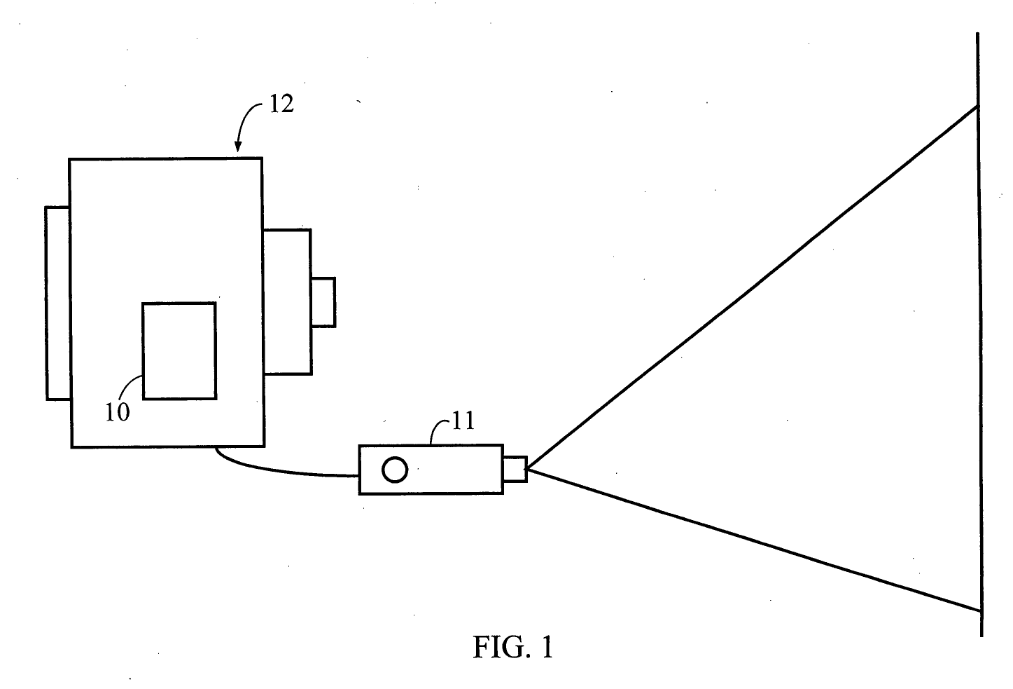

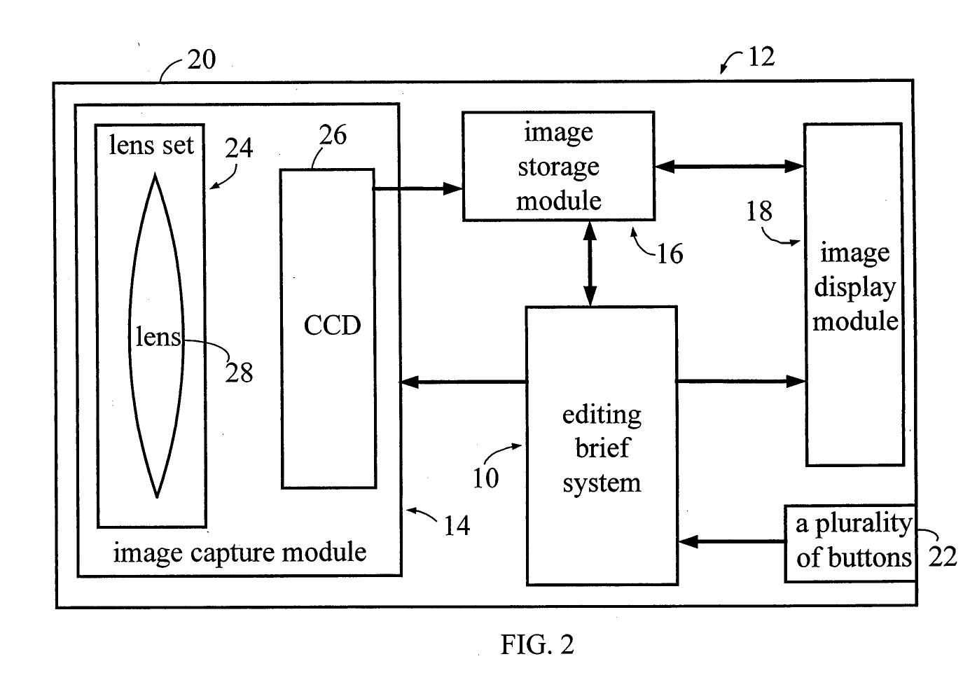

Please refer to FIG. 1 and FIG. 2. FIG. 1 is a schematic diagram of the editing brief system 10 used in a portable digital image capture device 12 according to the present invention. FIG. 2 is a function block diagram of the digital image capture device shown in FIG. 1. As shown in FIG. 1, the editing brief system 10 of the present invention is built in a portable digital image capture device 12 for providing users to edit a plurality of image files captured by the digital image capture device 12 and in further briefing. The way of briefing may be to display with a built-in image display module or to perform further briefing by connecting with an external projector 11 or a TV (not shown in FIG.) from the digital image capture device 12. The portable digital image capture device of the present invention may be a digital still camera (DSC), a digital video camera (DVC), or a PDA. Generally speaking, all the portable digital products, which have image capture and image display function, can utilize the editing brief system 10 of the present invention.

As shown in FIG. 2, the digital image capture device 12 comprises an image capture module 14 for capturing the plurality of image files, an image storage module 16 for storing the plurality of image files, and an image display module 18 for displaying the plurality of image files. The image capture module 14 comprises a lens set 24 and a charge coupled device (CCD) 26. The lens set 24 focuses the light of an image on the CCD 26 to enable the CCD 26 to generate the corresponding image of the image file. The image storage module 16 may be an external memory card. The image display module 18 may be a LCD panel. The digital image capture device 12 further comprises a housing 20 for accommodating the image capture module 14, the image storage module 16, the image display module 18, and the editing brief system 10. A plurality of buttons 22 are configured on the housing 20 for users to select and execute different functions.

When users want to capture an image, the image capture module 14 enables the light of an image to enter the lens set 24 and focus on the CCD 26. The CCD 26 further converts the image light to an image file, and the image file is stored in the image storage module 16. Then, the users can utilize a plurality of buttons 22 to control the editing brief system 10 to edit the image file. When editing is completed, the users can store the edited image file to the image storage module 16 or display the edited image file on the image display module 18. Furthermore, the users can connect an external projector to the digital image capture device 12 to brief with the edited image file.

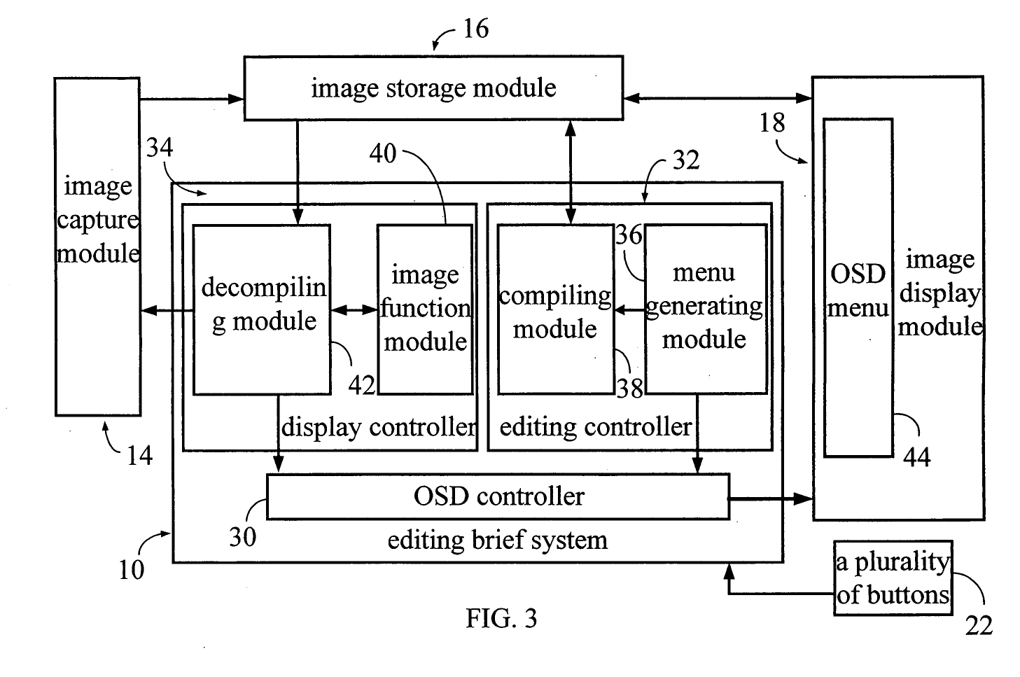

Please refer to FIG. 3. FIG. 3 is a function block diagram of the editing brief system 10 shown in FIG. 2. Each of the image files comprises a comment column and a corresponding image. How the editing brief system 10 utilizes the comment column to achieve the result of editing the image file will be described in the following with FIG. 3. The editing brief system 10 comprises an OSD controller 30, an editing controller 32, and a display controller 34. The editing controller 32 comprises a menu generating module 36, a compiling module 38, and an input interface. The menu generating module 36 enables the OSD controller 30 to generate an OSD menu 43, and the OSD menu 43 is displayed on the image display module 18. The OSD menu 43 and the plurality of buttons 22 on the housing 20 form the input interface. The input interface provides input options of a plurality of image and character editing functions for users to select and input and permits the users to edit the corresponding image and character in at least one target image file. The compiling module 38 compiles the selected inputs received by the input interface as a corresponding control code and records the control code in the comment column of the target image file in a way that does not destroy the image of the target image file, achieving the non-destructive editing of the target image file.

The non-destructive editing of the present invention is that the compiling module compiles the edited inputs received by the input interface as a corresponding control code and records the control code in the comment column of the target image file. In this way, the characters desired to be displayed in the image will not destroy the image of the target image file, and the corresponding control codes of pictures and literary compositions are separately recorded in the comment column. The advantage of this method is that the image of the target image file will not be destroyed by added words or character editing, and the original completeness will be kept. Moreover, the control code, generated after the image and characters are edited, are separately recorded in the comment column; this allows users to have the choice of displaying the image and character editing function or not, during further briefing. In other words, if users change their mind to only display the original static image, the editing brief system 10 just has to disable the control code in the comment column. Therefore, the original image will not be interfered or destroyed during the editing process.

The display controller 34 comprises an image function module 40 and a decompiling module 42. The image function module 40 is used for providing a plurality of predetermined image display functions. The decompiling module 42 is used for decompiling the control code recorded in the comment column of the target image file; according to the decompilied control code, the decompiling module enables the image function module 40 to display the images of the target image file by the edited image display function and the OSD controller 30 to render the characters of the target image file by the edited character rendering function.

The digital image capture device 12 may be a digital still camera (DSC), and the image file can be any image format of the following combinations: Exif 2.2, PIM2, or other similar image formats. In the above image formats, the comment column is the MAKENOTE column. The digital image capture device 12 may also be a digital video camera (DVC); the image file can be a MPEG image format, and the comment column is located at the end of the image file. The image formats or comment column mentioned above are just used as examples for illustration and are not used to limit the present invention. As long as there is a column for setting or marking in the image format, the editing brief system 10 of the present invention can utilize the image format according to the above detailed description without departing from the spirits of the invention.

Furthermore, the OSD menu 43 comprises a plurality of submenus (not shown in FIG. 3). The editing brief system 10 further comprises at least one look-up table (not shown in FIG. 3), which corresponds to the OSD menu 43. The compiling module 38 and the decompiling module 42 proceed to compile and decompile according to the look-up table.

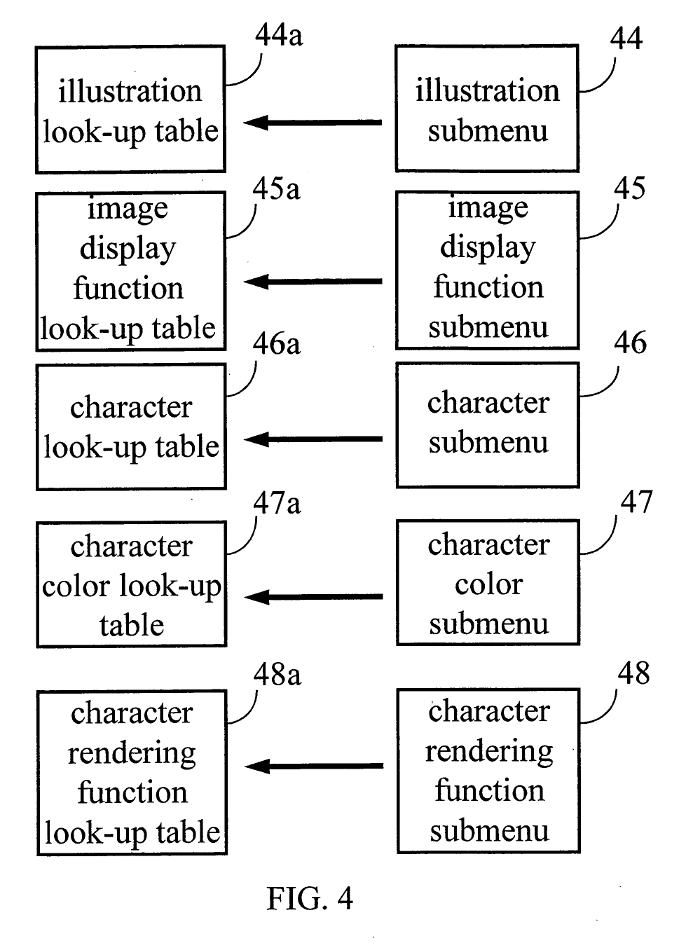

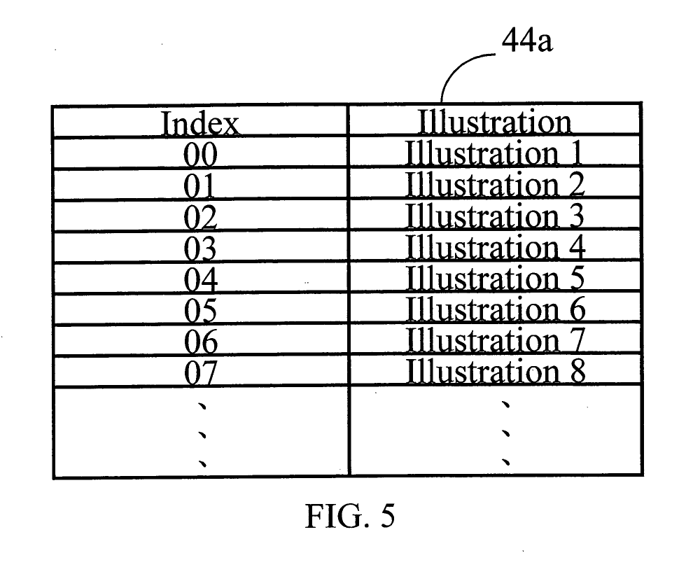

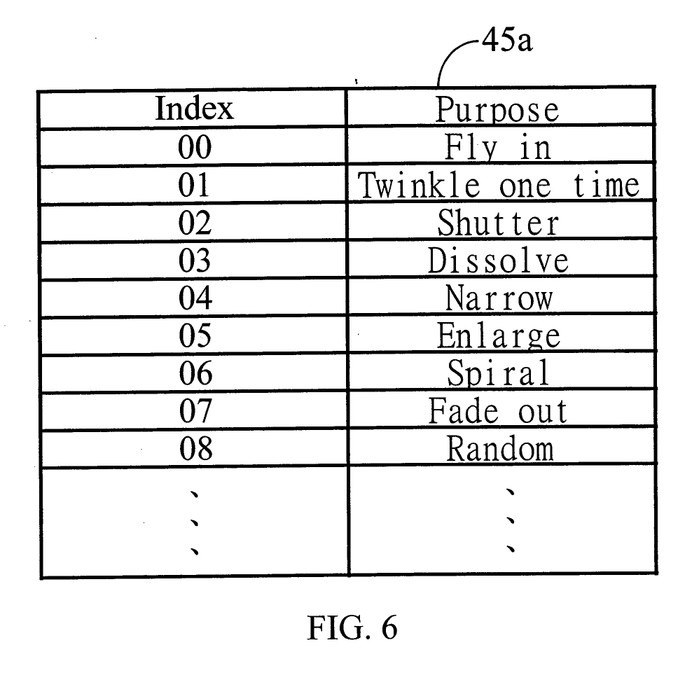

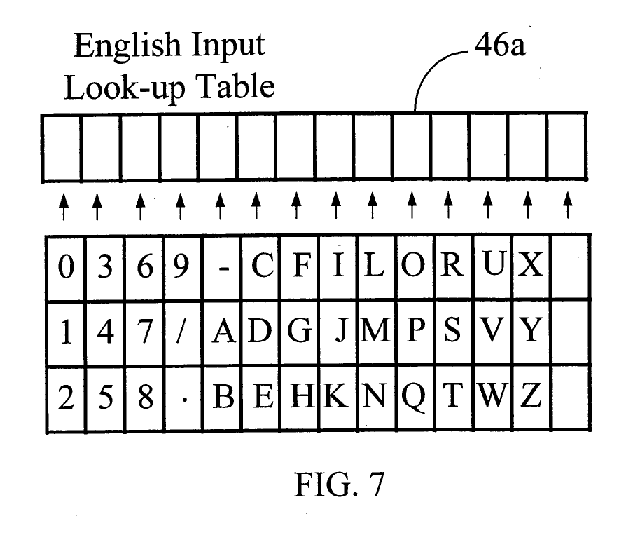

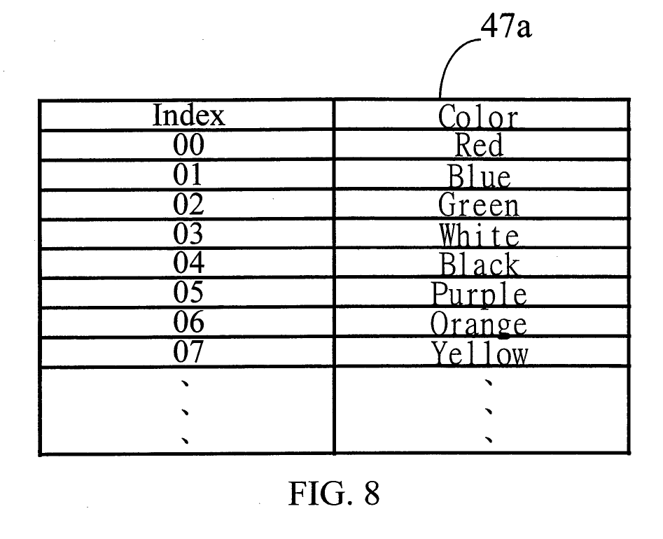

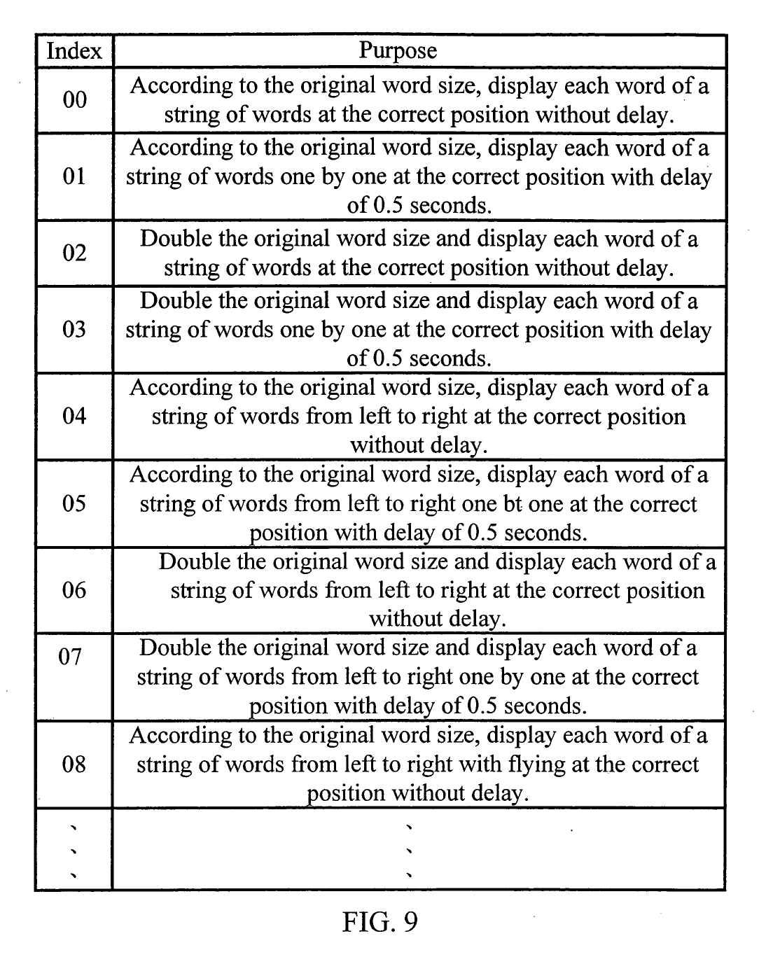

Please refer to FIG. 4 to FIG. 9. FIG. 4 is a schematic diagram of an OSD menu 43 and a corresponding look-up table shown in FIG. 3. FIG. 5 to FIG. 9 is an embodiment of an illustration look-up table 44a, an image display function look-up table 45a, a character look-up table 46a, a character color look-up table 47b, and a character rendering function look-up table 48a shown in FIG. 4. In the preferred embodiment of the present invention, the OSD menu 43 comprises an illustration submenu 44, an image display function submenu 45, a character submenu 46, a character color submenu 47, and a character rendering function submenu 48. The illustration submenu 44 is used for the users to select the desired illustration via a plurality of buttons 22. The image display function submenu 45 is used for the users to assign the corresponding image display function to the image of the target image file via a plurality of buttons 22. The character submenu 46 is used for the users to select the desired characters for input via a plurality of buttons 22. The character color submenu 47 is used for the users to assign the desired color to the desired characters via a plurality of buttons 22. The character rendering function submenu 48 is used for the users to assign the corresponding character rendering function to the desired characters via a plurality of buttons 22.

The editing brief system 10 further comprises five look-up tables corresponding to the OSD menu 43. The five look-up tables are illustration look-up table 44a, image display function look-up table 45a, character look-up table 46a, character color look-up table 47b, and character rendering function look-up table 48a, corresponding to the illustration submenu 44, the image display function submenu 45, the character submenu 46, the character color submenu 47, and the character rendering function submenu 48 respectively. FIG. 5 to FIG. 9 illustrates the embodiment of the illustration look-up table 44a, the image display function look-up table 45a, the character look-up table 46a, the character color look-up table 47b, and the character rendering function look-up table 48a respectively. And the character look-up table 46a may be an English alphabet look-up table, a phonetic character look-up table, or other language or symbol look-up table.

The compiling module 38 compiles the user's input options from the submenus 44, 45, 46, 47, and 48, according to the look-up table 44a, 45a, 46a, 47b, and 48a, and generates the corresponding control codes. During further briefing, the decompiling module 42 also decompiles the control codes according to the look-up table 44a, 45a, 46a, 47b, and 48a.

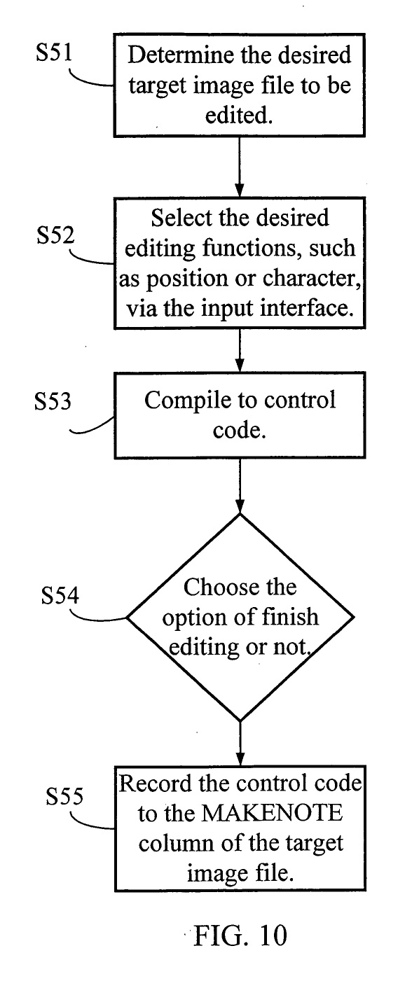

Please refer to FIG. 10. FIG. 10 is a flowchart of compiling an image file with the editing brief system 10 shown in FIG. 3. The editing brief system 10 of the present invention comprises the following steps to compile an image file:

S51: Determine the desired target image file to be edited.

S52: Select the desired editing functions, such as position, character, or illustration, via the input interface.

S53: Compile to corresponding control code via the compiling module 38.

S54: Choose the option of finish editing or not. If yes, go to S55; if no, go to S52.

S55: Record the control code to the MAKENOTE column of the target image file.

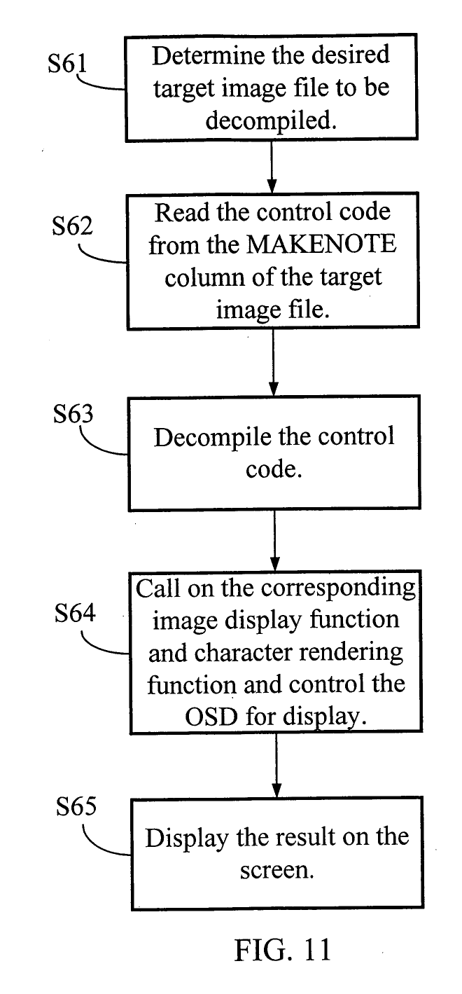

Please refer to FIG. 11. FIG. 11 is a flowchart of decompiling an image file with the editing brief system 10 shown in FIG. 3. The steps comprise:

S61: Determine the desired target image file to be decompiled.

S62: Read the control code from the MAKENOTE column of the target image file.

S63: Decompile the control code via the decompiling module 42.

S64: Call on the corresponding image display function and character rendering function and control the OSD for display.

S65: Display the result on the screen.

Besides, the edited image file of the present invention can be displayed on the built-in image display module or be briefed via the external projector. The users can also edit a power-on default image via the input interface or the provided submenu, so the image display module 18 displays the predetermined power-on default image each time when the digital image capture device 12 is turned on; therefore, the users can freely show their personal styles.

According to the above, the editing brief system used in a portable digital image capture device of the present invention provides a new method to edit briefing, wherein the editing controller and the display controller provide a plurality of predetermined image display functions for the users to select, input, and edit. Then, the compiling module compiles the user's selected inputs into corresponding control codes and records the control code in the comment column of the target image file in a way that does not destroy the image of the target image file. The advantage of this method of separating picture and literary compositions is the image of the target image file will not be destroyed by adding words or character editing, and the original completeness will be kept. The objective of the non-destructive editing of the target image file is achieved. Furthermore, if the users change their mind to edit the target image file with other types of editing or even cancel the completed editing function to restore the original static image, it wouldn't be a problem at all. Because of utilizing the MAKENOTE comment column of Exif 2.2 and PIM2, the original image will not be interfered or destroyed during the editing process, thus enabling the portable device to include the function of capturing, editing, and display. Therefore, the users edit images and characters and brief more conveniently.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An editing controller used in a portable digital image capture device for providing users to edit in a non-destructive way a plurality of image files captured by the digital image capture device, each of the plurality of image files comprising a comment column and a corresponding image, the digital image capture device comprising an image capture module for capturing the plurality of image files, an image storage module for storing the plurality of image files, and an image display module for displaying the plurality of image files, the editing controller comprising:
an input interface for providing input options of a plurality of image and character editing functions and permitting the users to edit the corresponding image and character in at least one target image file; and
a compiling module for compiling the selected inputs received by the input interface as a corresponding control code and recording the control code in the comment column of the target image file in a way that does not destroy the image of the target image file, to achieve the non-destructive editing of the target image file.

2. The editing controller of claim 1, wherein the digital image capture device is a digital still camera (DSC), the image file is any one image format of the following combinations: Exif 2.2 and PIM2, and the comment column is MAKENOTE column.

3. The editing controller of claim 1, wherein the digital image capture device is a digital video camera (DVC), the image file is an MPEG image format, and the comment column is located in the end of the image file.

4. The editing controller of claim 1, wherein the digital image capture device comprises a housing for accommodating the image capture module, the image storage module, and the image display module, and a plurality of buttons are configured on the housing.

5. The editing controller of claim 4, wherein the digital image capture device further comprises:
an on screen display (OSD) controller; and
a display controller, comprising:
an image function module for providing at least a predetermined image display function; and
a decompiling module for decompiling the control code recorded in the comment column of the target image file, and according to the decompiled control code, enabling the image function module to display the images of the target image file in the edited image display function and enabling the OSD controller to render the characters of the target image file in the edited character rendering function.

6. The editing controller of claim 5, wherein the editing controller further comprises a menu generating module so as to enable the OSD controller to generate an OSD menu and to display on the image display module, and the OSD menu and the buttons of the housing form the input interface to facilitate the users to select, input, and edit the images and characters on the target image file.

7. The editing controller of claim 6, wherein the OSD menu comprises:
an illustration submenu for the users to select the desired illustration via the buttons;
an image display function submenu for the users to assign the corresponding image display function to the image of the target image file via the buttons;
a character submenu for the users to select the desired characters via the buttons;
a character color submenu for the users to assign the desired color to the desired characters via the buttons; and
a character rendering function submenu for the users to assign the corresponding character rendering function to the desired characters via the buttons.

8. The editing controller of claim 7, wherein the digital image capture device further comprises at least one look-up table, and the compiling module compiles the user's input options from the submenus according to the look-up table and generates the corresponding control codes, and while in further briefing, the decompiling module also decompiles the control codes according to the look-up table.

9. A display controller used in a portable digital image capture device for providing users to edit in a non-destructive way a plurality of image files captured by the digital image capture device and in further displaying, each of the image files comprising a comment column and a corresponding image, the digital image capture device comprising an image capture module for capturing the image files, an image storage module for storing the image files, and an image display module for displaying the image files, the display controller comprising:
an image function module for providing at least one predetermined image display function; and
a decompiling module for decompiling a control code recorded in the comment column of the target image file, and according to the decompiled control code, enabling the image function module to display the images of the target image file in the edited image display function.

10. The display controller of claim 9, wherein, according to the decompiled control codes, the OSD controller also renders the characters of the target image file in the edited character rendering function.

11. The display controller of claim 9, wherein the digital image capture device is a DSC, the image file is any one image format of the following combinations: Exif 2.2 and PIM2, and the comment column is MAKENOTE column.

12. The display controller of claim 9, wherein the digital image capture device further comprises at least a look-up table, and the compiling module compiles the user's input options from the an OSD menu according to the look-up table and generates the corresponding control codes, and while in further briefing, the decompiling module also decompiles the control codes according to the look-up table.

13. An editing method used in a portable digital image capture device for providing users to edit in a non-destructive way a plurality of image files captured by the digital image capture device, each of the plurality of image files comprising a comment column and a corresponding image, the digital image capture device comprising an image capture module for capturing the plurality of image files, an image storage module for storing the plurality of image files, and an image display module for displaying the plurality of image files, the editing method comprising:
providing a plurality of predetermined image display functions;
providing an input interface having a plurality of input options of image and character editing functions and permitting the users to edit the corresponding image and character in at least one target image file; and
compiling the selected inputs received by the input interface as a corresponding control code and recording the control code in the comment column of the target image file in a way that does not destroy the image of the target image file, to achieve the non-destructive editing of the target image file.

14. The editing method of claim 13, wherein the digital image capture device is a DSC, the image file is any one image format of the following combinations: Exif 2.2 and PIM2, and the comment column is MAKENOTE column.

15. The editing method of claim 13, wherein the digital image capture device is a DVC, the image file is an MPEG image format, and the comment column is located in the end of the image file.

16. The editing method of claim 13, wherein the digital image capture device comprises a housing for accommodating the image capture module, the image storage module, and the image display module, and a plurality of buttons are configured on the housing; and the OSD menu displayed on the image display module and the buttons of the housing form the input interface to facilitate the users to select, input, and edit the images and characters on the target image file.

17. The editing method of claim 16, wherein the OSD menu comprises:
an illustration submenu for the users to select the desired illustration via the buttons;
an image display function submenu for the users to assign the corresponding image display function to the image of the target image file via the buttons;
a character submenu for the users to select the desired characters via the buttons;
a character color submenu for the users to assign the color to the desired characters via the buttons; and
a character rendering function submenu for the users to assign the corresponding character rendering function to the desired characters via the buttons.

18. The editing method of claim 16, wherein the users edit a predetermined power-on default image via the submenus, and the image display module displays the power-on default image each time when the digital image capture device is powered on.

19. A display method used in a portable digital image capture device for providing users to edit in a non-destructive way a plurality of image files captured by the digital image capture device and in further displaying, each of the image files comprising a comment column and a corresponding image, the digital image capture device comprising an image capture module for capturing the image files, an image storage module for storing the image files, and an image display module for displaying the image files, the display method comprising:
providing at least one predetermined image display function;
while receiving the displayed signal via an input interface, decompiling at least one control code recorded in the comment column of the target image file; and
according to the decompiled control codes, enabling the images of the target image file to be displayed in the edited image display function and enabling the characters of the target image file to be rendered in the edited character rendering function.

20. The display method of claim 19, wherein the users edit a predetermined power-on default image via the input interface, and the image display module displays the power-on default image each time when the digital image capture device is powered on.
